(19) United States
(12) Patent Application Publication
(10) Pub. No.: US 2006/0067021 A1
(43) Pub. Date: Mar. 30, 2006

(54) Over-voltage and over-current protection device

(76) Inventors: Xiang-Ming Li, San Diego, CA (US); Liwu Wang, San Diego, CA (US)

Correspondence Address: MORRISON & FOERSTER LLP, 12531 HIGH BLUFF DRIVE, SUITE 100, SAN DIEGO, CA, 92130-2040, US

(21) Appl. No.: 10/952,267

(22) Filed: Sep. 27, 2004

(51) Int. Cl. H02H 5/04

(52) U.S. Cl. 361/30

(57) ABSTRACT

An improved over-voltage and over-current protection device is provided. The device includes: a first over-current protection device disposed between a first electrically conductive terminal and a second electrically conductive terminal, wherein the first over-current protection device creates an open circuit when a current exceeding a certain level flows between the first terminal and the second terminal; a first over-voltage protection device electrically coupled to the first terminal, wherein the first over-voltage protection device clamps voltages applied to the first terminal below a specified level; and a second over-voltage protection device electrically coupled to the second terminal, wherein the second over-voltage protection device clamps voltages applied to the second terminal below a specified level.

### BACKGROUND OF THE INVENTION

1. Field of the Invention

The present invention relates to an improved over-voltage and over-current protection device for protecting electronic circuits from relatively high voltages and/or currents that may otherwise damage the electronic circuits.

2. Description of Related Art

Our contemporary society enjoys the convenience and utility offered by the plethora of modem electronic devices available to industry, businesses and consumers. Electronic devices, however, often contain circuitry or components that may be sensitive to certain levels of current or voltage. Spikes or otherwise higher-than-nominal voltage or current levels are often referred to as over-voltage or over-current conditions. The occurrence of over-voltage or over-current conditions may result in damage to or destruction of the circuitry or components of the electronic device. As a result, designers often utilize fuses, varistors, thyristors or other devices to shield the circuitry from such conditions.

Fuses are well known and widely used for over-current protection of electronic circuits. Many current limited fuses are made of metal wires, metal sheets, or metal films as the fusing elements. When the electrical current passing through the fusing element exceeds a certain level, the heat generated by the electrical current will melt the fusing element and create an open circuit, thereby preventing further current flow. Occasionally, however, when the fuse element melts or breaks an arcing effect occurs and allows undesired current levels to reach the circuit to be protected, potentially causing damage to the circuit. Therefore, the fusing elements are typically surrounded by arc suppressing or arc shielding materials. Many types and designs of fuses are known in the art and such fuses are described, for example, in U.S. Pat. Nos. 6,590,490; 6,005,470; 5,726,621; 5,479,147; 5,453,726; 5,296,833; 5,245,308; 5,228,188; and 2,864,917.

Over-voltage protection devices such as varistors, for example, are also well known and widely used for protecting electronic circuits from above-nominal voltage levels. A varistor is an electronic component designed to protect circuits against excessive voltage. The most common type is a metal oxide varistor (MOV). Similar to a capacitor, a varistor typically includes two metal plates or electrodes separated by an insulator. The insulator materials are typically semi-conducting materials, which have high resistance when a crossing voltage is low and have low resistance when the crossing voltage is high. When the voltage between the two electrodes reaches a certain value, the insulator breaks down and admits the flow of current (i.e., the breakdown current). Varistors have a capacitance and could be called capacitors; likewise, all capacitors have a breakdown voltage. The difference is that in most capacitors, breakdown is highly undesirable, and usually results in the destruction of the device. Varistors on the other hand are designed to repeatedly withstand breakdown.

FIG. 1 illustrates a circuit diagram of a conventional over-current and over-voltage protection device or module 100 having a fuse 102 located on one side of a varistor 104. Such protection circuits are disclosed, for example, in U.S. Pat. Nos. 6,636,404 and 6,510,032. As illustrated in FIG. 1, a power supply 106 is connected to a first terminal of the fuse 102. A second terminal of the fuse 102 is electronically connected to an electronic circuit 108 to be protected. A first electrode of the varistor 104 is connected to the second terminal of the fuse 102 and to the electronic circuit 108. A second electrode of the varistor 104 is connected to ground. Appropriate terminals (not shown) of the power supply 106 and the electronic circuit 108 are also connected to ground.

Because the protection module 100 described above and illustrated in FIG. 1 has the fuse 102 located on only one side of the varistor 104, the circuit's design is not symmetrical. Therefore, if the protection circuit 100 is implemented as a surface mount device or component, the orientation of the device when utilized in a printed circuit (PC) board, for example, is critical to the proper operation of the protection device 100. For example, a voltage pulse coming from the power supply 106 will have a different impact on the protection device 100 than a voltage pulse coming from the circuit 108. A voltage pulse coming from the power supply 106 will generate a break through current through the varistor 104. All of this break through current will pass through the fuse 102. If the current is high enough, it could blow the fuse 102. On the other hand, if a voltage pulse is generated from the circuit 108, the entire break through current of the varistor 104 will pass through the varistor 104 only, without giving extra stress on the fuse 102. Thus, in order to make sure that the protection module 100 is correctly inserted and oriented onto the PC board as intended by a circuit designer, a marking must be placed on the packaging of the protection module 100 to indicate the location of the varistor 104 and proper orientation of the protection module 100. This adds extra cost and difficulties during the manufacturing and automatic packaging of the protection module 100, as well as during assembly of the protection module 100 onto a PC board.

Furthermore, if an undesired voltage surge or spike is output by the power supply 106, in order for the varistor 104 to serve its intended function and clamp the voltage surge, the entire breakdown current of the varistor 104 must pass through the fuse 102. This places a significant limitation on the design of the protection circuit 100 because the fuse must have a high enough current rating to withstand the breakdown current generated by the voltage protection function of the varistor 104. In view of this limitation, prior protection circuits typically utilized a single layer or hollow tube varistor, which has a much smaller ratio of current carrying capacity to volume than that in a multilayer varistor. Such single-layer or hollow tube varistors are well known in the art and described, for example, in Japanese patent nos. 04-359403 and 05-013205.

In view of the above deficiencies associated with prior over-voltage and over-current protection circuits, there is a need for an improved over-voltage and over-current protection circuit that overcomes these deficiencies.

### SUMMARY OF THE INVENTION

The invention addresses the above and other needs by providing an over-voltage and over-current protection device wherein the breakdown current of a varistor, or other over-voltage protection device, need not all pass through a fuse of the protection device during voltage protection operation of the varistor (i.e., when it is in its breakdown state) or other over-voltage protection device. Thus, the current rating of the fuse may be designed in accordance with the current rating of the electronic circuit to be protected without being overly concerned with the breakdown current of the varistor.

In one embodiment, the over-voltage and over-current protection device of the present invention is characterized by a symmetrical design wherein a fuse is positioned between two varistors. A first terminal of the fuse is electrically connected to a first electrode of a first varistor and a second terminal of the fuse is electrically connected to a first electrode of a second varistor. Second electrodes of the first and second varistors are connected to ground. Thus, the orientation of the protection circuit on a PC board, for example, is not important because the protection circuit will behave the same regardless of its orientation when placed between a power source and an electronic circuit to be protected. In this way, an external marking on the package of the protection circuit is no longer required because the orientation of the protection circuit does not need to be taken into account during manufacturing of the protection module and assembly of the protection module onto a PC board.

In further embodiments, two or more parallel varistors (i.e., a multi-layer varistor) may be coupled to each terminal of one or more fuses, wherein if more than one fuse is utilized, the fuses are configured in parallel with one another.

In one embodiment, the protection circuit of the present invention is implemented as a multilayer surface mount component adapted for use on a printed circuit (PC) board.

### BRIEF DESCRIPTION OF THE DRAWINGS

FIG. 1 illustrates a diagram of an equivalent circuit of a prior art over-voltage and over-current protection device coupled between a power supply and an electronic circuit.

FIG. 2 illustrates a diagram of an equivalent circuit of an over-voltage and over-current protection device in accordance with one embodiment of the invention. The protection device is coupled between a power supply and an electronic circuit to be protected.

FIG. 3 illustrates a perspective view of an over-voltage and over-current protection device implemented as a surface mount component or module, in accordance with one embodiment of the invention.

FIG. 4 illustrates a cross-sectional side view of the surface mount component of FIG. 3, in accordance with one embodiment of the invention.

FIG. 5 illustrates a cross-sectional top view of the surface mount component of FIG. 3, in accordance with one embodiment of the invention.

FIG. 6 illustrates a diagram of an equivalent circuit of an over-voltage and over- current protection device in accordance with one embodiment of the invention.

FIG. 7 illustrates a cross-sectional side view of a surface mount component incorporating the over-voltage and over-current protection circuit of FIG. 6, in accordance with one embodiment of the invention.

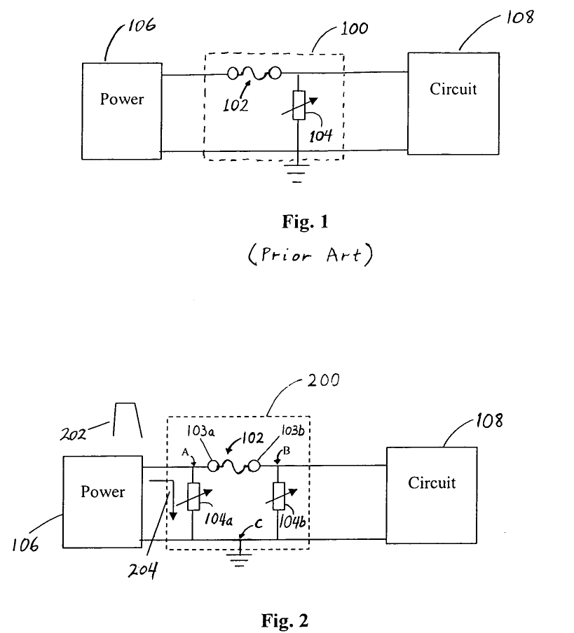

### DETAILED DESCRIPTION OF THE PREFERRED EMBODIMENTS

The invention, in accordance with various preferred embodiments, is described in detail below with reference to the figures, wherein like elements are referenced with like numerals throughout. In the embodiments discussed below, varistors are described as the over-voltage protection device used in conjunction with one or more fuses. However, it is understood and appreciated that other types of over-voltage protection devices may be implemented in the invention by those of skill in the art without undue experimentation. For example, instead of varistors, other known over-voltage protection devices such as thyristors, diodes, electric static discharge (ESD) protection devices (e.g., polymer composite devices such as those described in U.S. Pat. Nos. 6,642,297, 6,160,695 and 5,476,714), and well known gas discharge tube devices may be utilized in the present invention.

FIG. 2 illustrates an equivalent circuit diagram of a protection device or module 200 coupled to a power supply 106 at a first side of the module 200 and to an electronic circuit 108 at a second side. The protection module 200 includes a fuse 102 having a first end of its fuse element electrically coupled to a first terminal 103a of the module 200 and a second end of the fuse element connected to a second terminal 103b of the module 200. As shown in FIG. 2, varistors 104a and 104b are each connected to a respective terminal 103a or 103b. A first electrode (A) of a first varistor 104a is connected to terminal 103a, and hence electrically coupled to the first end of the fuse element of the fuse 102, and a first electrode (B) of a second varistor 104b is connected to terminal 103b, and hence electrically coupled to the second end of the fuse element of the fuse 102. A second electrode (C) of each of the varistors 104a and 104b is connected to ground.

Terminal 103a of the protection device or module 200 is connected to a first terminal of the power supply 106 and terminal 103b of the protection device or module 200 is connected to a first terminal of the electronic circuit 108. Appropriate terminals of the power supply 106 and the electronic circuit 108 are also connected to ground.

During operation, if the power supply 106 outputs a voltage surge 202 that is above a pre-specified voltage level, the first varistor 104a will breakdown and allow a breakdown current 204 to flow through it, thereby clamping or reducing the voltage surge 202 below a certain level. In this way, the circuit 108 is protected from the voltage surge 202. Additionally, it should be noted that the entire breakdown current 204 of the varistor 104a need not pass through the fuse 102 when the device 200 is functioning as an over-voltage protection device. Rather, only a fraction of the breakdown current (e.g., approximately 50%) need pass through the fuse 102, which provides significantly more flexibility in designing the fuse 102.

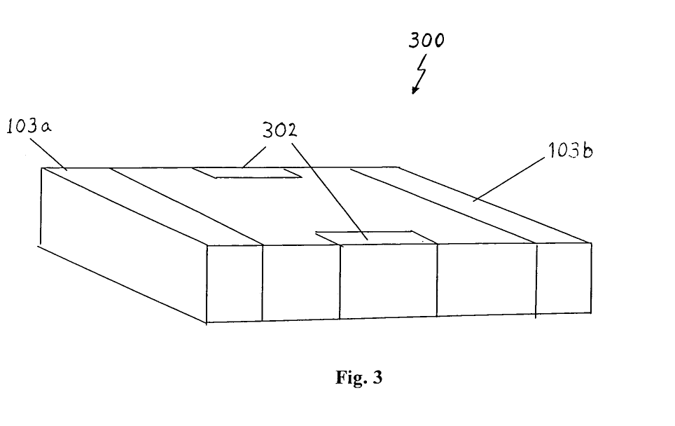

FIG. 3 illustrates a perspective view of a protection circuit implemented as a surface mount component or module 300, in accordance with one embodiment of the invention. The protection module 300 includes a first contact terminal 103a, which corresponds to the terminal 103a illustrated in FIG. 2, and a second contact terminal 103b located on an opposite end of the module 300 from the first contact terminal 103a, which corresponds to the terminal 103b of FIG. 2. When placed and assembled onto a PC board, the contact terminals 103a and 103b provide electrical contacts for the fuse 102 and varistors 104a and 104b contained within the module 300 to external circuits and/or components (e.g., a power supply and/or integrated circuit chip), which are also assembled onto or otherwise coupled to the PC board.

The protection module 300 further includes a pair of side ground terminals 302 located on opposite sides of the module 300 from one another. These ground terminals 302 are adapted to provide an electrical conduction path to ground for the fuse 102 and varistors 104a and 104b contained within the module 300.

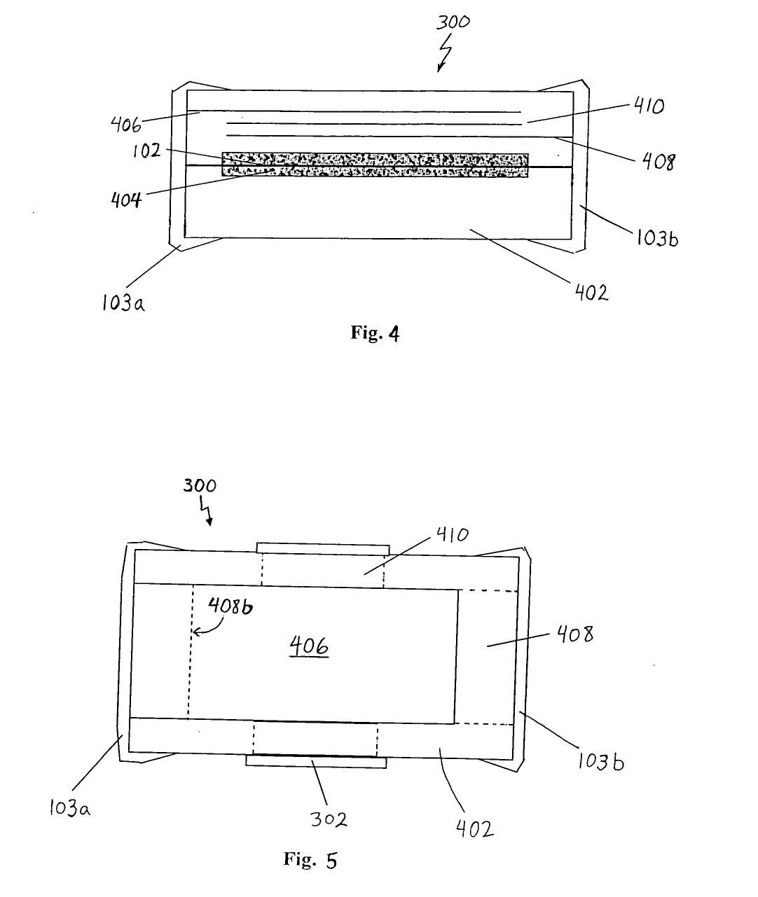

FIG. 4 illustrates a cross-sectional side view of the protection circuit module 300 of FIG. 3, in accordance with one embodiment of the invention. In the embodiment illustrated, the module 300 comprises multiple layers of a semiconducting and/or insulating material. Various types of semiconducting and insulating materials, which may be utilized in the present invention, are known in the art. Such materials are collectively referred to herein as an “insulator” or “insulating material.”

As shown in FIG. 4, the fuse 102 is placed on a top surface of a first insulator layer 402. A first end of the fuse 102 is electrically coupled to a first contact terminal 103a and a second end of the fuse 102 is electrically coupled to a second contact terminal 103b. In one embodiment, an arc suppressant material 404 surrounds or encloses the fuse element of the fuse 102 in order to suppress arcing and cut off the current through the arc, which may otherwise damage the electronic circuit to be protected. When the electrical current passing through the fusing element exceeds a certain level, the heat generated by the electrical current will melt the fusing element and create metal vapors, which in turn can generate high-current arcing. In order to quench or suppress the arc, several materials such as ceramic powder, glass, organic materials, etc., are known and used to enclose the fusing element and absorb the metal vapor that results when the fusing element melts and vaporizes. By absorbing the metal vapor, the arc suppressant material 404 prevents arcing and cuts off high current levels from reaching the electronic circuit to be protected.

Composite fusing elements wherein an arc suppressant material encloses or “sandwiches” a metal or alloy conducting material between two or more layers of arc suppressant material are known in the art. Such encapsulated or “sandwiched” composite fusing elements may be used in accordance with the invention. In other embodiments, an improved fuse element made from a composite mixture of conductive particles (e.g., a powder) and arc suppressant particles, or particles of one material coated with a film of the other material, may be utilized in the present invention. Such improved fuse elements, and methods of making same, are described in a concurrently-filed and commonly-owned U.S. patent application entitled, “Composite Fuse Element and Methods of Making Same,” attorney docket no. 38666-2000100, the entirety of which is incorporated by reference herein.

Referring again to FIG. 4, a first electrode 406 comprises a metal and/or alloy conductive plate having one end in electrical contact with the terminal 103a. This first electrode corresponds to electrode A of varistor 104a in FIG. 2. A second electrode 408 comprises a metal or alloy conductive plate having one end in electrical contact with the second terminal 103b. This second electrode 408 corresponds to electrode B of the second varistor 104b in FIG. 2. A third electrode 410 comprising a metal or alloy conductive plate is disposed between electrodes 406 and 408. This third electrode 410 is in electrical contact with one or both of the side ground terminals 302 (FIG. 3) and corresponds to a common ground electrode (C) shared by both of the varistors 104a and 104b. A layer of insulating material separates each of the electrodes 106, 108 and 110. Thus, the electrode 106 (A), the electrode 110 (C) and an insulating layer between these electrodes make up the varistor 104a (FIG. 2). The electrode 108 (B), the electrode 110 (C) and an insulating layer therebetween make up the varistor 104b.

When the voltage between the electrodes 106 and 110 of varistor 104a reaches a certain value, the insulator between the electrodes will break down and allow the flow of current (i.e., the breakdown current). In this way, varistor 104a will clamp the voltage between its electrodes below a predetermined breakdown voltage. Similarly, when the voltage between electrodes 108 and 110 of varistor 104b reaches a certain value, the insulator between the electrodes will break down and allow the flow of current between the electrodes, thereby clamping the voltage across varistor 104b. It should be noted that the figures provided herein are not necessarily drawn to scale.

FIG. 5 illustrates a cross-sectional top view of the protection circuit module 300. The first electrode 406 (A) is in electrical contact with the first terminal 103a and extends across the length of the module 300 but does not reach the second terminal 103b. The second electrode 408 (B) is diposed below the first electrode 406 and below intermediate insulating layers as indicated by dashed lines. The second electrode 408 is in electrical contact with the second terminal 103b and extends partially across the length of the module 300 but does not make electrical contact with the first terminal 103a. The end of the second electrode 408 is indicated by the dashed line 408b in FIG. 5.

Sandwiched between the electrodes 406 and 408 and between two insulating layers (not shown) is the third electrode 410 (C). As illustrated by dashed lines in FIG. 5, the third electrode 410 extend outwardly to make electrical contact with each of two opposing side contact terminals 302. In alternative embodiments, the third electrode 410 need only make electrical contact with one of the side contact terminals 302. As discussed above, the terminals 103a, 103b and 302 provide the electrical contacts for surface mount component 300 (FIG. 3) so that the component 300 is easily assembled onto a PC board (not shown) using well known surface mount assembly techniques.

As discussed above with respect to FIGS. 2-5, in one embodiment, the over-voltage and over-current protection circuit has a symetrical design. In other words, a power supply or electronic circuit to be protected may be connected to either terminal 103a or 103b because the circuit configuration and functionality is the same either way the protection circuit module 300 is oriented between a power supply and a circuit to be protected.

Additionally, an over-voltage pulse from either side of the fuse 102 will mainly generate current in a corresponding varistor 104a or 104b coupled to that same side of the fuse 102, reducing the breakdown current of the varistor through the fuse 102. In an extreme case, the fuse 102 has approximately zero resistance. Thus, the varistors 104a and 104b approximate a pair of varistors connected in parallel. During an over-voltage protection state, current passing through the fuse 102 is approximately equal to half of the normal breakdrown current through a single varistor because the pair of varistors 104a and 104b will share the current load. Thus, the current rating of the fuse 102 can be dictated mostly by the current limiting protection requirments of the electronic circuit to be protected, without being substantially limited by the breakdown current generated by the varistor 104a or 104b for clamping an over-voltage pulse or spike. Thus, the design of the protection device 100 of the present invention provides greater flexibility than prior art designs of over-voltage and over-current protection devices.

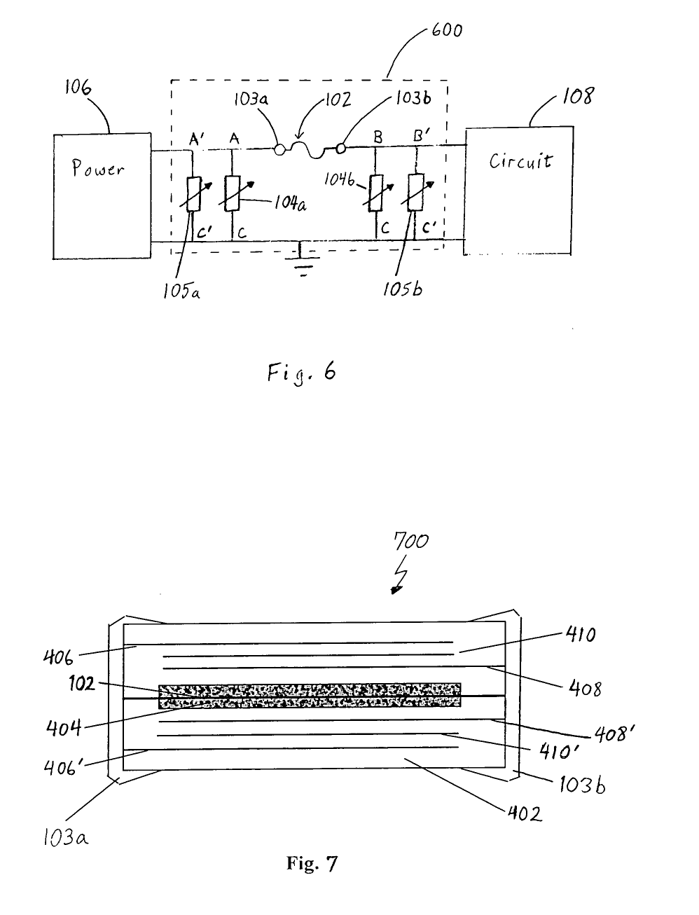

FIG. 6 illustrates an equivalent circuit diagram of an over-voltage and over-current protection device 600, in accordance with another embodiment of the invention. The protection device 600 is substantially similar to the protection device 200 of FIG. 2 except that additional varistors 105a and 105b are placed in parallel with respective varistors 104a and 104b on both sides of the fuse 102. By adding multiple varistors in parallel, the breakdown current can be increased and the protection device 600 can handle higher current levels when it is performing its over-voltage protection function. It is noted that multiple single-layer varistors connected in parallel are equivalent to a single multi-layer varistor.

In further embodiments (not illustrated), multiple fuses 102 can be connected in parallel between the contact terminals 103a and 103b. In this way, the current rating of the over-current protection function can also be increased.

FIG. 7 illustrates a cross sectional, side view of the protection circuit 600 of FIG. 6 when implemented as a multi-layer, surface mount component 700. This device 700 is substantially similar to the protection device or module 300 described above with respect to FIGS. 2-5. Elements 102, 103a, 103b, 402, 404, 406, 408 and 410 are identical to the elements referenced with the same numerals in FIG. 4. Therefore, the reader is directed to the previous discussion of these elements. However, FIG. 7 further illustrates the additional electrodes and insulating layers that form the additional parallel varistors 105a and 105b of FIG. 6.

As shown in FIG. 7, an additional electrode 406′ (A′) is in electrical contact with the terminal 103a and an additional electrode 408′ (B′) is in electrical contact with the terminal 103b. An additional ground electrode 410′ (C′) is disposed between the electrodes 406′ and 408′ and separating each of the electrodes 406′, 408′ and 410′ is a layer of insulating material 402.

Thus, the electrode 406′, the electrode 410′ and the insulating layer between these electrodes form the varistor 105a (FIG. 6). Because electrodes 406 and 406′ are both connected to terminal 103a and electrodes 410 and 410′ are both connected to one or more ground terminal 302 (FIGS. 3 and 5), varistor 105a is electrically connected in parallel with the varistor 104a. Similarly, the electrode 408′, the electrode 410′ and the insulating layer between these electrodes form the varistor 105b. Since the electrodes 408 and 408′ are both connected to the terminal 103b and the electrodes 410 and 410′ are both connected to one or more ground terminals 302, varistor 105b is electrically connected in parallel with varistor 104b. It is appreciated that parallel varistors 104a and 105a can be viewed as a single multi-layer varistor structure. Similarly, varistors 104b and 105b can be viewed as a single multi-layer varistor structure.

In further embodiments, one or multiple parallel varistors 104 can be placed on either side of one or multiple parallel fuses 102, depending on the desired breakdown current of the varistor(s) and/or current rating of the fuse element(s).

In one embodiment, the fuse element of a fuse 102 is located near the center of the module 300, 700, as illustrated in FIGS. 4 and 7, for example. In alternative embodiments, the fuse 102 can be located off-center of the module 300, 700. When multiple fuses 102 are implemented in the design, corresponding fuse elements can be located close to one another or separated from one another by varistor electrodes and insulating layers.

Devices in accordance with the embodiments described above can be manufactured using various known techniques, such as a dry sheet process, a wet coating process, a screen printing process, or a UV forming process. The subsequent cutting, sintering, termination, and plating processes are similar to those widely adopted in the multilayer ceramic component manufacturing industry. These processes are well known by those of skill in the art.

Various preferred embodiments of the invention have been described above. However, it is understood that these various embodiments are exemplary only and should not limit the scope of the invention as recited in the claims below. Various modifications of the preferred embodiments described above can be implemented by those of ordinary skill in the art, without undue experimentation. For example, alternative over-voltage protection devices (e.g., thyristors, diodes, etc.) may be used instead of the varistors described above. These various modifications are contemplated to be within the spirit and scope of the invention as set forth in the claims below.

What is claimed is:

1. An over-voltage and over-current protection device, comprising:
a first fuse element having a first end and a second end opposite the first end;
a first varistor having a first electrode electrically coupled to the first end of the first fuse element and a second electrode adapted to be electrically coupled to ground; and
a second varistor having a first electrode electrically coupled to the second end of the first fuse element and a second electrode adapted to be electrically coupled to ground.

2. The protection device of claim 1 configured as a surface mount component further comprising:
a first terminal electrically coupled to the first end of the first fuse element and the first electrode of the first varistor;
a second terminal electrically coupled to the second end of the first fuse element and the first electrode of the second varistor; and
a third terminal electrically coupled to the second electrodes of the first and second varistors.

3. The protection device of claim 2 wherein the second electrodes of the first and second varistors are provided by a single electrode commonly shared by the first and second varistors.

4. The protection device of claim 2 wherein the first fuse element includes a composite material comprising a conductive plate or wire enclosed by an arc suppressant material.

5. The protection device of claim 2 wherein the fuse element includes a composite material made from mixing a conductive material powder with an arc suppressant material powder.

6. The protection device of claim 2 wherein the fuse element includes a composite material made from coating arc suppressant material particles with a film of conductive material.

7. The protection device of claim 2 further comprising a third varistor electrically connected in parallel with the first varistor and a fourth varistor electrically connected in parallel with the second varistor.

8. The protection device of claim 2 further comprising a second fuse element electrically connected in parallel with the first fuse element.

9. The protection device of claim 1 wherein the first fuse element includes a composite material comprising a conductive plate or wire enclosed by an arc suppressant material.

10. The protection device of claim 1 wherein the fuse element includes a composite material made from mixing a conductive material powder with an arc suppressant material powder.

11. The protection device of claim 1 wherein the fuse element includes a composite material made from coating arc suppressant material particles with a film of conductive material.

12. The protection device of claim 1 further comprising a third varistor electrically connected in parallel with the first varistor and a fourth varistor electrically connected in parallel with the second varistor.

13. The protection device of claim 1 further comprising a second fuse element electrically connected in parallel with the first fuse element.

14. A multi-layer over-voltage and over-current protection module, comprising:
a first fuse element disposed between a first contact terminal and a second contact terminal, the first fuse element having a first end electrically coupled to the first contact terminal and a second end electrically coupled to the second contact terminal;
a first electrode electrically coupled to the first contact terminal;
a second electrode electrically coupled to the second contact terminal;
a third electrode electrically coupled to a third contact terminal, which is electrically insulated from the first and second contact terminals; and
a plurality of insulating layers disposed between the first, second and third electrodes and the first fuse element, such that at least one insulating layer separates the first, second and third electrodes and the first fuse element from one another.

15. The module of claim 14 wherein the first fuse element is sandwiched between two layers of arc suppressant material.

16. The module of claim 14 wherein the first fuse element includes a composite material made from mixing a conductive material powder with an arc suppressant material powder.

17. The module of claim 14 wherein the first fuse element includes a composite material made from coating arc suppressant material particles with a film of conductive material.

18. The module of claim 14 wherein:
the first electrode, the third electrode and a first insulating layer disposed between the first electrode and the third electrode form a first varistor; and
the second electrode, the third electrode and a second insulating layer disposed between the second electrode and the third electrode form a second varistor.

19. The module of claim 18 further comprising:
a fourth electrode electrically coupled to the first contact terminal;
a fifth electrode electrically coupled to the second contact terminal;
a sixth electrode electrically coupled to the third contact terminal;
a third layer of insulating material disposed between the fourth and sixth electrodes, thereby forming a third varistor electrically coupled in parallel with the first varistor; and
a fourth layer of insulating material disposed between the fifth and sixth electrodes, thereby forming a fourth varistor electrically coupled in parallel with the second varistor.

20. The module of claim 14 further comprising a second fuse element disposed between the first and second contact terminals and electrically coupled in parallel with the first fuse element.

21. An over-voltage and over-current protection device, comprising:
a first over-current protection device disposed between a first electrically conductive terminal and a second electrically conductive terminal, wherein the first over- current protection device creates an open circuit when a current exceeding a certain level flows between the first terminal and the second terminal;
a first over-voltage protection device electrically coupled to the first terminal, wherein the first over-voltage protection device clamps voltages applied to the first terminal below a specified level; and
a second over-voltage protection device electrically coupled to the second terminal, wherein the second over-voltage protection device clamps voltages applied to the second terminal below a specified level.

22. The device of claim 21 wherein the first over-current protection device comprises a first fuse, the first over-voltage protection device comprises a first varistor and the second over-voltage protection device comprises a second varistor.

23. The device of claim 22 wherein the first and second varistors each comprise a multi-layer varistor.

24. The device of claim 22 further comprising a second fuse connected in parallel with the first fuse between the first and second terminals.
